(19) United States
(12) Patent Application Publication
(10) Pub. No.: US 2007/0143245 A1
(43) Pub. Date: Jun. 21, 2007

(54) System and method for managing presentation of query results

(75) Inventors: Richard D. Dettinger, Rochester, MN (US); Janice R. Glowacki, Rochester, MN (US); Daniel P. Kolz, Rochester, MN (US); Padma S. Rao, Rochester, MN (US); Marci L. Sperber, Rochester, MN (US); Shannon E. Wenzel, Colby, WI (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/303,524

(22) Filed: Dec. 16, 2005

(51) Int. Cl. G06F 17/30

(52) U.S. Cl. 707/2

(57) ABSTRACT

A method, system and article of manufacture for managing presentation of query results. One embodiment comprises receiving, from a requesting entity, a query having at least (i) one result field for which data from one or more databases is to be returned, (ii) one or more conditions for filtering which of the data contained in the one or more databases is returned for each result field, and (iii) a conditions object defining at least one expression for at least one of the conditions. The query is executed against the one or more databases to obtain a query result having one or more data records. The query result is returned in a format relating the data records to respective expressions on the basis of which conditions the data records satisfy. Thereby, it is exposed which of the data records satisfy respective conditions having defined expressions in the conditions object.

### CROSS-REFERENCE TO RELATED APPLICATION

This application is related to the following commonly owned application: U.S. patent application Ser. No. 10/083,075, filed Feb. 26, 2002, entitled “APPLICATION PORTABILITY AND EXTENSIBILITY THROUGH DATABASE SCHEMA AND QUERY ABSTRACTION”, which is hereby incorporated herein in its entirety.

### BACKGROUND OF THE INVENTION

1. Field of the Invention

The present invention generally relates to managing presentation of query results and, more particularly, to managing presentation of query results including different groups of data records.

2. Description of the Related Art

Databases are computerized information storage and retrieval systems. A relational database management system is a computer database management system (DBMS) that uses relational techniques for storing and retrieving data. The most prevalent type of database is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Regardless of the particular architecture, a DBMS can be structured to support a variety of different types of operations. Such operations can be configured to retrieve, add, modify and delete information being stored and managed by the DBMS. Standard database access methods support these operations using high-level query languages, such as the Structured Query Language (SQL). The term “query” denominates a set of commands that cause execution of operations for processing data from a stored database. For instance, SQL supports four types of query operations, i.e., SELECT, INSERT, UPDATE and DELETE. A SELECT operation retrieves data from a database, an INSERT operation adds new data to a database, an UPDATE operation modifies data in a database and a DELETE operation removes data from a database.

Any requesting entity, including applications, operating systems and, at the highest level, users, can issue queries against data in a database. Queries may be predefined (i.e., hard coded as part of an application) or may be generated in response to input (e.g., user input). Upon execution of a query against a database, a query result is returned to the requesting entity.

One of the difficulties for users in running queries is to discern relevant information from result sets. In particular, the users often attempt to understand the result set from the perspective of “entities”, a logical representation of related data. For example, in a medical data environment the focus of research is often on patients, a type of entity. Most of the relevant data in a medical data environment is in the form of continuous ranges of values, meaning that patients can have a multiplicity of tests with different values for each test. As a result, the database contains large amounts of data, but very little structured information about patients or other entities.

In order to extract meaningful information from the database users manually identify related conditions in a given query, where each group of related conditions exposes some meaningful information. For instance, assume a researcher who performs a statistical analysis in a hospital to determine information about individuals belonging to a first group of patients and/or a second group of patients. By way of example, the first group of patients consists of myeloid leukemia patients with a hemoglobin value which is determined using a given hemoglobin test and which lies within a given range of values. The second group of patients consists of chronic myeloid leukemia patients with a hemoglobin value which is determined using another hemoglobin test and which lies within another range of values.

Assume now that the researcher issues a single query against one or more underlying databases to determine information about the individuals belonging to the first and/or second group of patients. The query is executed against the underlying database(s) and a single query result is obtained having a multiplicity of data records. Each data record relates to an individual that is included with the first and/or the second group of patients. Assume further that the researcher wants to view the data records that relate to the first, the second and the first and second groups of patients separately. To this end, the researcher needs to identify manually which data record(s) from the obtained query result relates to which group(s) of patients. Thus, the process of identifying which records are related to which groups of query conditions is a tedious process which is error prone and time consuming, particularly where the result set is voluminous.

Therefore, there is a need for an efficient technique for managing presentation of query results including different groups of data records.

### SUMMARY OF THE INVENTION

The present invention is generally directed to a method, system and article of manufacture for managing presentation of query results and, more particularly, for managing presentation of query results including different groups of data records.

One embodiment provides a method for managing presentation of a query result. The method comprises receiving, from a requesting entity, a query having at least (i) one result field for which data from one or more databases is to be returned, (ii) one or more conditions for filtering which of the data contained in the one or more databases is returned for each result field, and (iii) a conditions object defining at least one expression for at least one of the conditions. The method further comprises executing the query against the one or more databases to obtain a query result having one or more data records. The query result is returned in a format relating the data records to respective expressions on the basis of which conditions the data records satisfy. Thereby, it is exposed which of the data records satisfy respective conditions having defined expressions in the conditions object.

Another embodiment provides a computer-readable medium containing a program which, when executed by a processor, performs a process for managing presentation of a query result. The process comprises receiving, from a requesting entity, a query having at least (i) one result field for which data from one or more databases is to be returned, (ii) one or more conditions for filtering which of the data contained in the one or more databases is returned for each result field, and (iii) a conditions object defining at least one expression for at least one of the conditions. The process further comprises executing the query against the one or more databases to obtain a query result having one or more data records. The query result is returned in a format relating the data records to respective expressions on the basis of which conditions the data records satisfy. Thereby, it is exposed which of the data records satisfy respective conditions having defined expressions in the conditions object.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a computer system illustratively utilized in accordance with the invention;

FIGS. 2-3 are relational views of software components in one embodiment;

FIGS. 4-5 are flow charts illustrating the operation of a runtime component;

FIG. 6 is a relational view of software components in one embodiment;

FIG. 7 is a flow chart illustrating query execution management in one embodiment;

FIG. 8 is a flow chart illustrating identification of data records associated with different groups of information in one embodiment;

FIG. 9 is a flow chart illustrating identification of data records associated with different groups of information in another embodiment; and

FIG. 10 is a flow chart illustrating a method of formatting a query result in one embodiment.

### DETAILED DESCRIPTION OF THE PREFERRED EMBODIMENTS

Introduction

The present invention is generally directed to a method, system and article of manufacture for managing presentation of query results and, more particularly, for managing presentation of query results including different groups of data records. In general, a query result is obtained in response to execution of a query against one or more underlying databases, each having a multiplicity of data records. The query includes at least one result field for which data from the underlying database(s) is to be returned in the query result. The query may further include one or more conditions for filtering which of the data records contained in the underlying database(s) are returned for each result field.

In one embodiment, a given query further includes a conditions object that defines one or more expressions, each representing a conditional statement that is defined using a single condition or a subset of the conditions of the query. According to one aspect, a given expression can be created by a user selecting one or more conditions from the query and defining a conditional statement on the basis of the selected condition(s).

The query is executed against the underlying database(s) to obtain the query result and the expression(s) defined by the conditions object is included with the query result as metadata. In one embodiment, the metadata further includes a list of data record identifiers for each expression defined by the conditions object. The list of identifiers of a given expression indicates which data record in the query result satisfies the conditional statement defining the expression. Accordingly, using the metadata the query result can be presented in a format relating each data record to a respective expression(s), whereby it can be exposed which of the data records satisfy respective conditional statements representing expressions that are defined in the conditions object.

### PREFERRED EMBODIMENTS

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

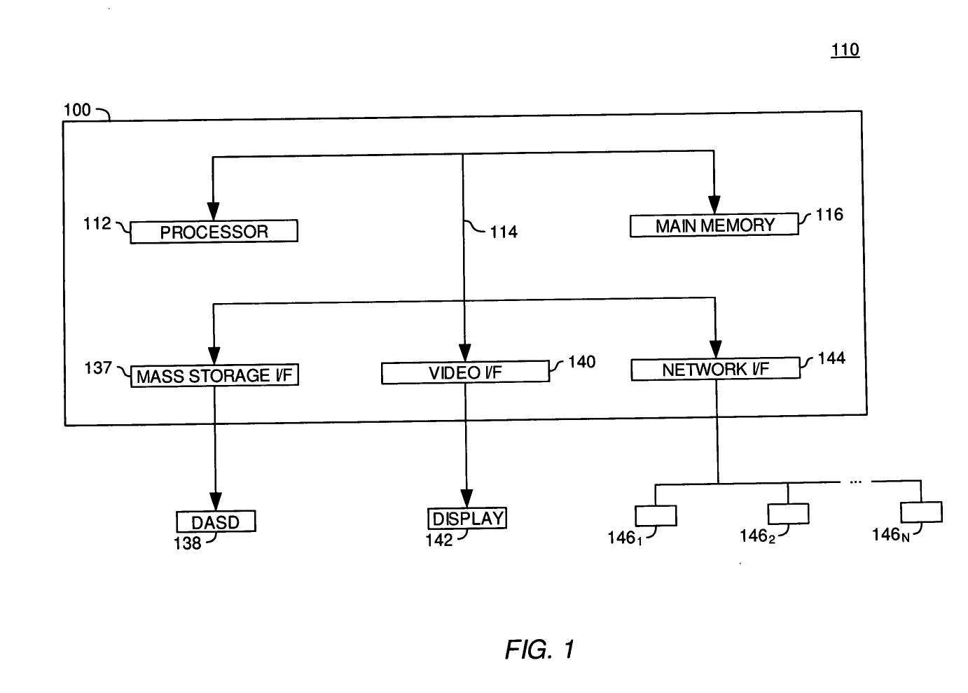

One embodiment of the invention is implemented as a program product for use with a computer system such as, for example, computer system 110 shown in FIG. 1 and described below. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

### AN EXEMPLARY COMPUTING ENVIRONMENT

FIG. 1 shows a computer 100 (which is part of a computer system 110) that becomes a special-purpose computer according to an embodiment of the invention when configured with the features and functionality described herein. The computer 100 may represent any type of computer, computer system or other programmable electronic device, including a client computer, a server computer, a portable computer, a personal digital assistant (PDA), an embedded controller, a PC-based server, a minicomputer, a midrange computer, a mainframe computer, and other computers adapted to support the methods, apparatus, and article of manufacture of the invention. Illustratively, the computer 100 is part of a networked system 110. In this regard, the invention may be practiced in a distributed computing environment in which tasks are performed by remote processing devices that are linked through a communications network. In a distributed computing environment, program modules may be located in both local and remote memory storage devices. In another embodiment, the computer 100 is a standalone device. For purposes of construing the claims, the term “computer” shall mean any computerized device having at least one processor. The computer may be a standalone device or part of a network in which case the computer may be coupled by communication means (e.g., a local area network or a wide area network) to another device (i.e., another computer).

In any case, it is understood that FIG. 1 is merely one configuration for a computer system. Embodiments of the invention can apply to any comparable configuration, regardless of whether the computer 100 is a complicated multi-user apparatus, a single-user workstation, or a network appliance that does not have non-volatile storage of its own.

The computer 100 could include a number of operators and peripheral systems as shown, for example, by a mass storage interface 137 operably connected to a storage device 138, by a video interface 140 operably connected to a display 142, and by a network interface 144 operably connected to the plurality of networked devices 146 (which may be representative of the Internet) via a suitable network. Although storage 138 is shown as a single unit, it could be any combination of fixed and/or removable storage devices, such as fixed disc drives, floppy disc drives, tape drives, removable memory cards, or optical storage. The display 142 may be any video output device for outputting viewable information.

Computer 100 is shown comprising at least one processor 112, which obtains instructions and data via a bus 114 from a main memory 116. The processor 112 could be any processor adapted to support the methods of the invention. In particular, the computer processor 112 is selected to support the features of the present invention. Illustratively, the processor is a PowerPC® processor available from International Business Machines Corporation of Armonk, N.Y.

The main memory 116 is any memory sufficiently large to hold the necessary programs and data structures. Main memory 116 could be one or a combination of memory devices, including Random Access Memory, nonvolatile or backup memory, (e.g., programmable or Flash memories, read-only memories, etc.). In addition, memory 116 may be considered to include memory physically located elsewhere in the computer system 110, for example, any storage capacity used as virtual memory or stored on a mass storage device (e.g., direct access storage device 138) or on another computer coupled to the computer 100 via bus 114. Thus, main memory 116 and storage device 138 could be part of one virtual address space spanning multiple primary and secondary storage devices.

### LOGICAL/RUNTIME VIEW OF ENVIRONMENT

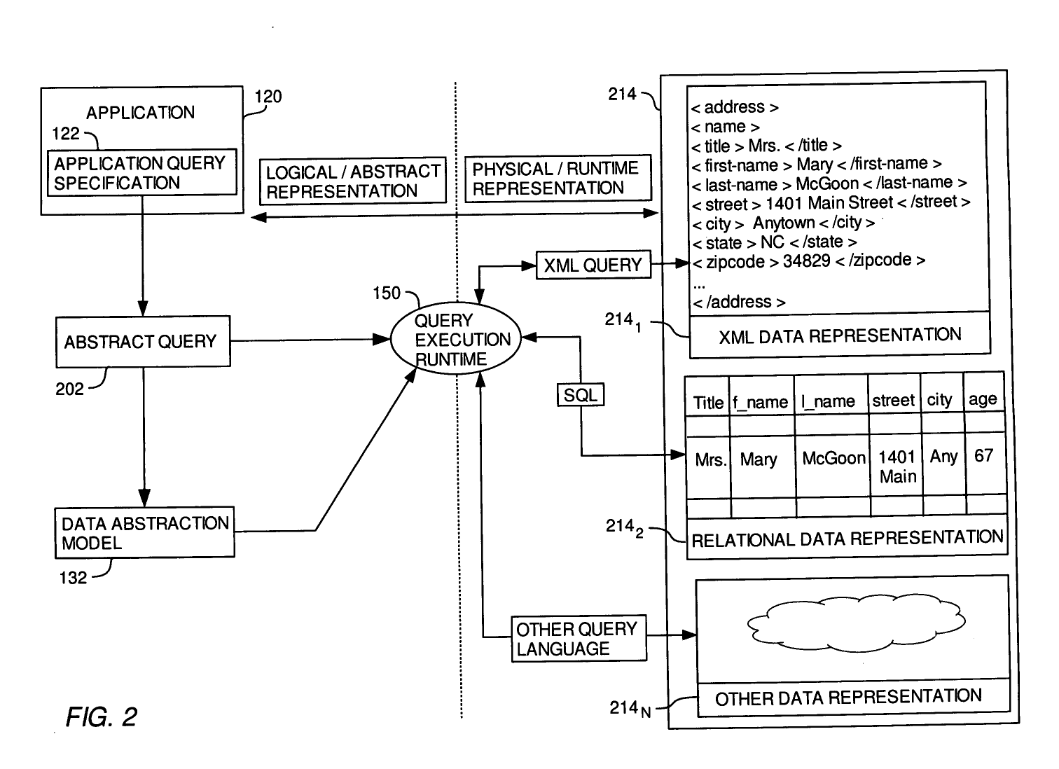

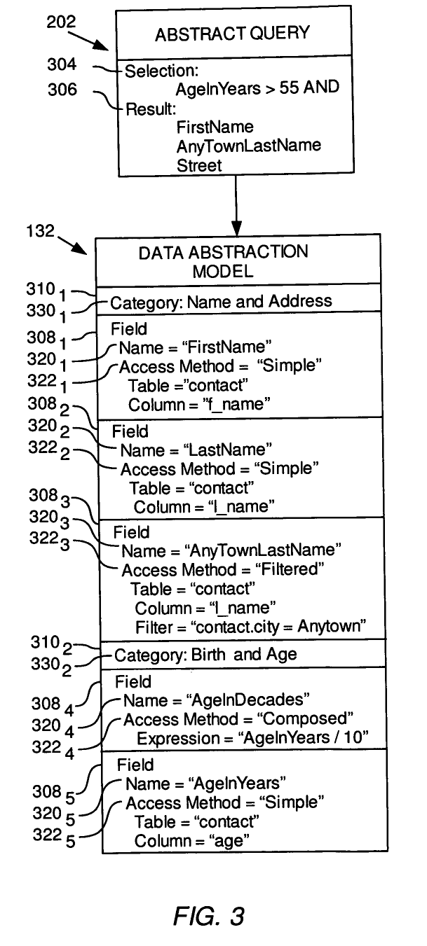

FIGS. 2-3 show an illustrative relational view of software components in one embodiment. According to one aspect, the software components are configured for query execution management and illustratively include one or more applications 120, a data abstraction model 132 and a database 214. By way of example, the database 214 includes a plurality of exemplary physical data representations 214₁, 214₂, . . . 214_{N}.

The application(s) 120 is configured to issue queries against the database 214. However, it should be noted that any suitable requesting entity including an operating system and, at the highest level, users may issue queries against the database 214. Accordingly, all such different implementations are broadly contemplated.

The queries issued by the application(s) 120 may be predefined (i.e., hard coded as part of the application(s) 120) or may be generated in response to input (e.g., user input). In one embodiment, the application(s) 120 issues a query 202 as defined by a corresponding application query specification 122. The resulting query 202 is generally referred to herein as an “abstract query” because the query is composed according to abstract (i.e., logical) fields rather than by direct reference to underlying physical data entities in the database 214. The logical fields are defined by the data abstraction model 132 which generally exposes information as a set of logical fields that may be used within a query (e.g., the abstract query 202) issued by the application(s) 120 to specify criteria for data selection and specify the form of result data returned from a query operation. In one embodiment, the application query specification 122 may include both criteria used for data selection (selection criteria 304) and an explicit specification of the fields to be returned (return data specification 306) based on the selection criteria 304, as illustrated in FIG. 3.

The logical fields of the data abstraction model 132 are defined independently of the underlying data representation (i.e., one of the plurality of exemplary physical data representations 214_{1-N}) being used in the database 214, thereby allowing queries to be formed that are loosely coupled to the underlying data representation. More specifically, a logical field defines an abstract view of data whether as an individual data item or a data structure in the form of, for example, a database table. As a result, abstract queries such as the query 202 may be defined that are independent of the particular underlying data representation used. Such abstract queries can be transformed into a form consistent with the underlying physical data representation 214_{1-N} for execution against the database 214. By way of example, the abstract query 202 is translated by a runtime component 150 into a concrete (i.e., executable) query which is executed against the database 214 to determine a corresponding result set for the abstract query 202.

In one embodiment, illustrated in FIG. 3, the data abstraction model 132 comprises a plurality of field specifications 308₁, 308₂, 308₃, 308₄ and 308₅ (five shown by way of example), collectively referred to as the field specifications 308 (also referred to hereinafter as “field definitions”). Specifically, a field specification is provided for each logical field available for composition of an abstract query. Each field specification may contain one or more attributes. Illustratively, the field specifications 308 include a logical field name attribute 320₁, 320₂, 320₃, 320₄, 320₅ (collectively, field name 320) and an associated access method attribute 322₁, 322₂, 322₃, 322₄, 322₅ (collectively, access methods 322). Each attribute may have a value. For example, logical field name attribute 320₁ has the value “FirstName” and access method attribute 322₁ has the value “Simple”. Furthermore, each attribute may include one or more associated abstract properties. Each abstract property describes a characteristic of a data structure and has an associated value. In the context of the invention, a data structure refers to a part of the underlying physical representation that is defined by one or more physical entities of the data corresponding to the logical field. In particular, an abstract property may represent data location metadata abstractly describing a location of a physical data entity corresponding to the data structure, like a name of a database table or a name of a column in a database table. Illustratively, the access method attribute 322₁ includes data location metadata “Table” and “Column”. Furthermore, data location metadata “Table” has the value “contact” and data location metadata “Column” has the value “f_name”. Accordingly, assuming an underlying relational database schema in the present example, the values of data location metadata “Table” and “Column” point to a table “contact” having a column “f_name”.

In one embodiment, groups (i.e. two or more) of logical fields may be part of categories. Accordingly, the data abstraction model 132 includes a plurality of category specifications 310₁ and 310₂ (two shown by way of example), collectively referred to as the category specifications. In one embodiment, a category specification is provided for each logical grouping of two or more logical fields. For example, logical fields 308₁₋₃ and 308₄₋₅ are part of the category specifications 310₁ and 310₂, respectively. A category specification is also referred to herein simply as a “category”. The categories are distinguished according to a category name, e.g., category names 330₁ and 330₂ (collectively, category name(s) 330). In the present illustration, the logical fields 308₁₋₃ are part of the “Name and Address” category and logical fields 308₄₋₅ are part of the “Birth and Age” category.

The access methods 322 generally associate (i.e., map) the logical field names to data in the database (e.g., database 214 of FIG. 2). As illustrated in FIG. 2, the access methods associate the logical field names to a particular physical data representation 214_{1-N} in the database. By way of illustration, two data representations are shown, an XML data representation 214₁ and a relational data representation 214₂. However, the physical data representation 214_{N} indicates that any other data representation, known or unknown, is contemplated. In one embodiment, a single data abstraction model 132 contains field specifications (with associated access methods) for two or more physical data representations 214_{1-N}. In an alternative embodiment, a different single data abstraction model 132 is provided for each separate physical data representation 214_{1-N}.

Any number of access methods is contemplated depending upon the number of different types of logical fields to be supported. In one embodiment, access methods for simple fields, filtered fields and composed fields are provided. The field specifications 308₁, 308₂ and 308₅ exemplify simple field access methods 322₁, 322₂, and 322₅, respectively. Simple fields are mapped directly to a particular entity in the underlying physical representation (e.g., a field mapped to a given database table and column). By way of illustration, as described above, the simple field access method 322₁ shown in FIG. 3 maps the logical field name 320₁ (“FirstName”) to a column named “f_name” in a table named “contact”. The field specification 308₃ exemplifies a filtered field access method 322₃. Filtered fields identify an associated physical entity and provide filters used to define a particular subset of items within the physical representation. An example is provided in FIG. 3 in which the filtered field access method 322₃ maps the logical field name 320₃ (“AnyTownLastName”) to a physical entity in a column named “I_name” in a table named “contact” and defines a filter for individuals in the city of “Anytown”. Another example of a filtered field is a New York ZIP code field that maps to the physical representation of ZIP codes and restricts the data only to those ZIP codes defined for the state of New York. The field specification 308₄ exemplifies a composed field access method 322₄. Composed access methods compute a logical field from one or more physical fields using an expression supplied as part of the access method definition. In this way, information which does not exist in the underlying physical data representation may be computed. In the example illustrated in FIG. 3 the composed field access method 322₄ maps the logical field name 320₄ “AgeInDecades” to “AgeInYears/10”. Another example is a sales tax field that is composed by multiplying a sales price field by a sales tax rate.

It is contemplated that the formats for any given data type (e.g., dates, decimal numbers, etc.) of the underlying data may vary. Accordingly, in one embodiment, the field specifications 308 include a type attribute which reflects the format of the underlying data. However, in another embodiment, the data format of the field specifications 308 is different from the associated underlying physical data, in which case a conversion of the underlying physical data into the format of the logical field is required.

By way of example, the field specifications 308 of the data abstraction model 132 shown in FIG. 3 are representative of logical fields mapped to data represented in the relational data representation 214₂ shown in FIG. 2. However, other instances of the data abstraction model 132 map logical fields to other physical representations, such as XML.

An illustrative abstract query corresponding to the abstract query 202 shown in FIG. 3 is shown in Table I below. By way of illustration, the illustrative abstract query is defined using XML. However, any other language may be used to advantage.

TABLE I
ABSTRACT QUERY EXAMPLE

| | |
|---|---|
| 001 | <?xml version=“1.0”?> |
| 002 | <!--Query string representation: (AgeInYears > “55”--> |
| 003 | <QueryAbstraction> |
| 004 | <Selection> |
| 005 | <Condition internalID=“4”> |
| 006 | <Condition field=“AgeInYears” operator=“GT” value=“55” |
| 007 | internalID=“1”/> |
| 008 | </Selection> |
| 009 | <Results> |
| 010 | <Field name=“FirstName”/> |
| 011 | <Field name=“AnyTownLastName”/> |
| 012 | <Field name=“Street”/> |
| 013 | </Results> |
| 014 | </QueryAbstraction> |

Illustratively, the abstract query shown in Table I includes a selection specification (lines 004-008) containing selection criteria and a results specification (lines 009-013). In one embodiment, a selection criterion consists of a field name (for a logical field), a comparison operator (=, >, <, etc) and a value expression (what is the field being compared to). In one embodiment, result specification is a list of abstract fields that are to be returned as a result of query execution. A result specification in the abstract query may consist of a field name and sort criteria.

An illustrative data abstraction model (DAM) corresponding to the data abstraction model 132 shown in FIG. 3 is shown in Table II below. By way of illustration, the illustrative Data Abstraction Model is defined using XML. However, any other language may be used to advantage.

TABLE II
DATA ABSTRACTION MODEL EXAMPLE

| | |
|---|---|
| 001 | <?xml version=“1.0”?> |
| 002 | <DataAbstraction> |
| 003 | <Category name=“Name and Address”> |
| 004 | <Field queryable=“Yes” name=“FirstName” |
| | displayable=“Yes”> |
| 005 | <AccessMethod> |
| 006 | <Simple columnName=“f_name” |
| | tableName=“contact”></Simple> |
| 007 | </AccessMethod> |
| 008 | </Field> |
| 009 | <Field queryable=“Yes” name=“LastName” |
| | displayable=“Yes”> |
| 010 | <AccessMethod> |
| 011 | <Simple columnName=“l_name” |
| | tableName=“contact”></Simple> |
| 012 | </AccessMethod> |
| 013 | </Field> |
| 014 | <Field queryable=“Yes” name=“AnyTownLastName” |
| | displayable=“Yes”> |
| 015 | <AccessMethod> |
| 016 | <Filter columnName=“l_name” tableName=“contact” |
| 017 | Filter=”contact.city=Anytown”> </Filter> |
| 018 | </AccessMethod> |
| 019 | </Field> |
| 020 | </Category> |
| 021 | <Category name=“Birth and Age”> |
| 022 | <Field queryable=“Yes” name=“AgeInDecades” |
| | displayable=“Yes”> |
| 023 | <AccessMethod> |
| 024 | <Composed columnName=“age” tableName=“contact” |
| 025 | Expression=“column Name/10”> </Composed> |
| 026 | </AccessMethod> |
| 027 | </Field> |
| 028 | <Field queryable=“Yes” name=“AgeInYears” |
| | displayable=“Yes”> |
| 029 | <AccessMethod> |
| 030 | <Simple columnName=“age” |
| | tableName=“contact”></Simple> |
| 031 | </AccessMethod> |
| 032 | </Field> |
| 033 | </Category> |
| 034 | </DataAbstraction> |

By way of example, note that lines 004-008 correspond to the first field specification 308₁ of the DAM 132 shown in FIG. 3 and lines 009-013 correspond to the second field specification 308₂.

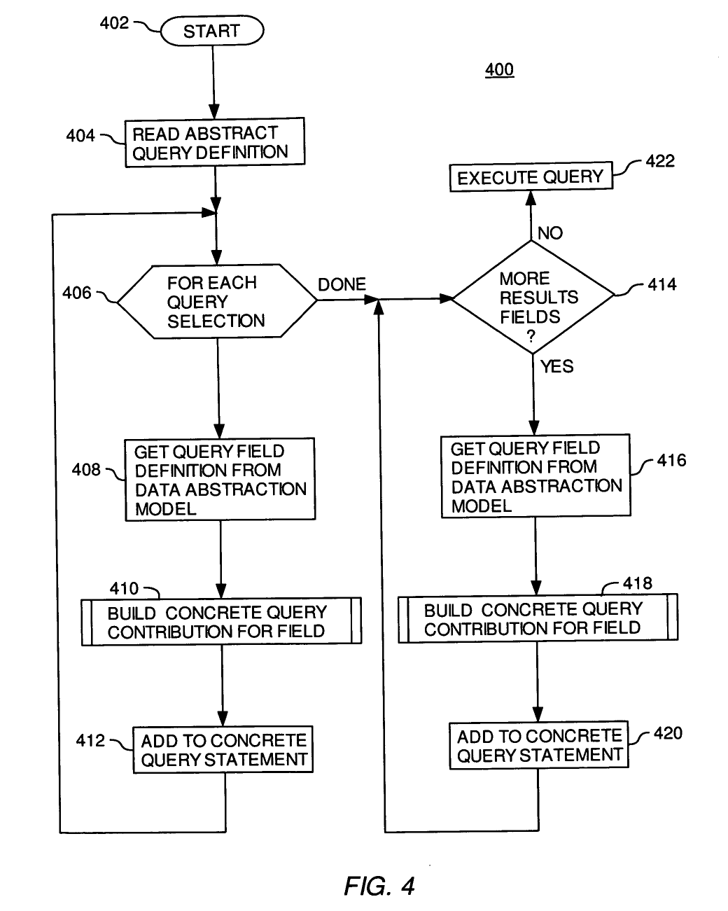

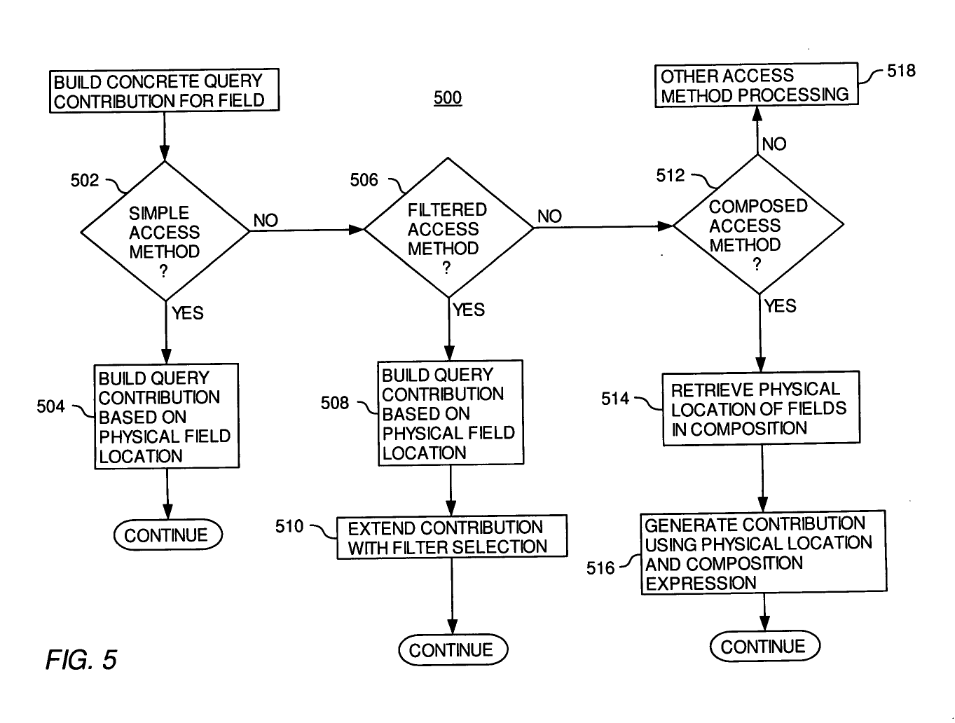

As was noted above, the abstract query of Table I can be transformed into a concrete query for query execution. An exemplary method for transforming an abstract query into a concrete query is described below with reference to FIGS. 4-5.

### TRANSFORMING AN ABSTRACT QUERY INTO A CONCRETE QUERY

Referring now to FIG. 4, an illustrative runtime method 400 exemplifying one embodiment of transforming an abstract query (e.g., abstract query 202 of FIGS. 2-3) into a concrete query using the runtime component 150 of FIG. 2 is shown. The method 400 is entered at step 402 when the runtime component 150 receives the abstract query (such as the abstract query shown in Table I) as input. At step 404, the runtime component 150 reads and parses the abstract query and locates individual selection criteria and desired result fields. At step 406, the runtime component 150 enters a loop (defined by steps 406, 408, 410 and 412) for processing each query selection criteria statement present in the abstract query, thereby building a data selection portion of a concrete query. In one embodiment, a selection criterion consists of a field name (for a logical field), a comparison operator (=, >, <, etc) and a value expression (what is the field being compared to). At step 408, the runtime component 150 uses the field name from a selection criterion of the abstract query to look up the definition of the field in the data abstraction model 132. As noted above, the field definition includes a definition of the access method used to access the data structure associated with the field. The runtime component 150 then builds (step 410) a concrete query contribution for the logical field being processed. As defined herein, a concrete query contribution is a portion of a concrete query that is used to perform data selection based on the current logical field. A concrete query is a query represented in languages like SQL and XML Query and is consistent with the data of a given physical data repository (e.g., a relational database or XML repository). Accordingly, the concrete query is used to locate and retrieve data from the physical data repository, represented by the database 214 shown in FIG. 2. The concrete query contribution generated for the current field is then added to a concrete query statement (step 412). The method 400 then returns to step 406 to begin processing for the next field of the abstract query. Accordingly, the process entered at step 406 is iterated for each data selection field in the abstract query, thereby contributing additional content to the eventual query to be performed.

After building the data selection portion of the concrete query, the runtime component 150 identifies the information to be returned as a result of query execution. As described above, in one embodiment, the abstract query defines a list of result fields, i.e., a list of logical fields that are to be returned as a result of query execution, referred to herein as a result specification. A result specification in the abstract query may consist of a field name and sort criteria. Accordingly, the method 400 enters a loop at step 414 (defined by steps 414, 416, 418 and 420) to add result field definitions to the concrete query being generated. At step 416, the runtime component 150 looks up a result field name (from the result specification of the abstract query) in the data abstraction model 132 and then retrieves a result field definition from the data abstraction model 132 to identify the physical location of data to be returned for the current logical result field. The runtime component 150 then builds (at step 418) a concrete query contribution (of the concrete query that identifies physical location of data to be returned) for the logical result field. At step 420, the concrete query contribution is then added to the concrete query statement. Once each of the result specifications in the abstract query has been processed, the concrete query is executed at step 422.

One embodiment of a method 500 for building a concrete query contribution for a logical field according to steps 410 and 418 is described with reference to FIG. 5. At step 502, the method 500 queries whether the access method associated with the current logical field is a simple access method. If so, the concrete query contribution is built (step 504) based on physical data location information and processing then continues according to method 400 described above. Otherwise, processing continues to step 506 to query whether the access method associated with the current logical field is a filtered access method. If so, the concrete query contribution is built (step 508) based on physical data location information for a given data structure(s). At step 510, the concrete query contribution is extended with additional logic (filter selection) used to subset data associated with the given data structure(s). Processing then continues according to method 400 described above.

If the access method is not a filtered access method, processing proceeds from step 506 to step 512 where the method 500 queries whether the access method is a composed access method. If the access method is a composed access method, the physical data location for each sub-field reference in the composed field expression is located and retrieved at step 514. At step 516, the physical field location information of the composed field expression is substituted for the logical field references of the composed field expression, whereby the concrete query contribution is generated. Processing then continues according to method 400 described above.

If the access method is not a composed access method, processing proceeds from step 512 to step 518. Step 518 is representative of any other access method types contemplated as embodiments of the present invention. However, it should be understood that embodiments are contemplated in which less then all the available access methods are implemented. For example, in a particular embodiment only simple access methods are used. In another embodiment, only simple access methods and filtered access methods are used.

### AN EXEMPLARY QUERY CREATION AND EXECUTION ENVIRONMENT

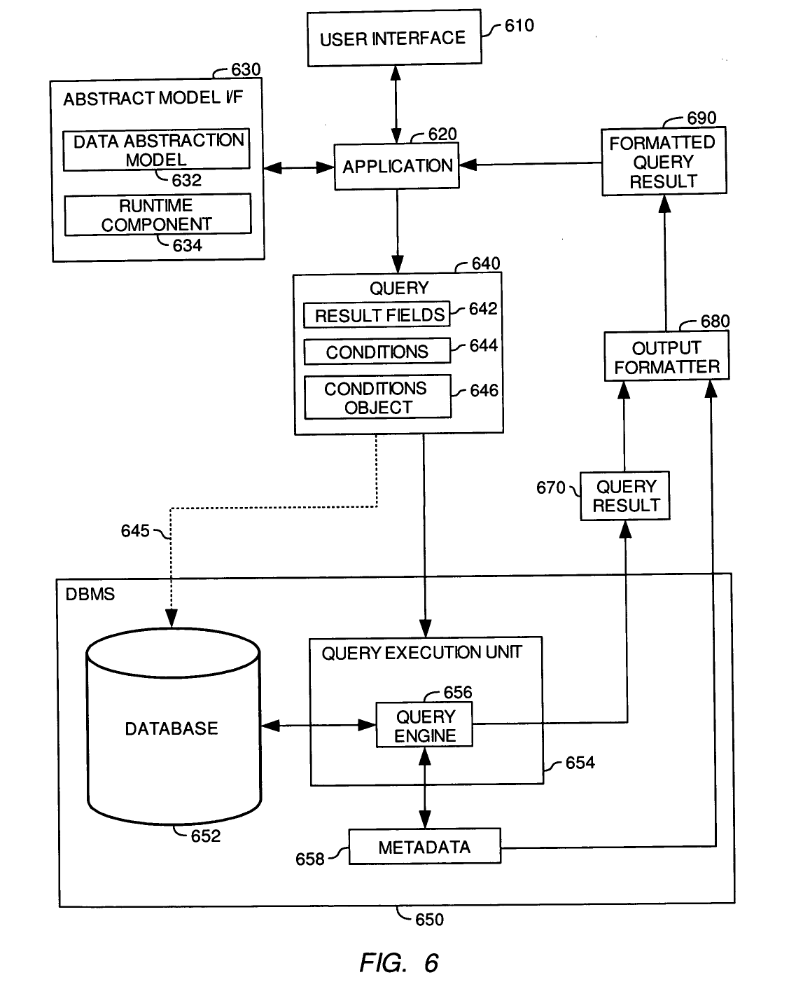

Referring now to FIG. 6, a relational view of software components in one embodiment is illustrated. The software components illustratively include a user interface 610, a DBMS 650, one or more applications 620 (only one application is illustrated for simplicity), an output formatter 680 and an abstract model interface 630. The abstract model interface 630 illustratively provides an interface to a data abstraction model 632 (e.g., data abstraction model 132 of FIG. 2) and a runtime component 634 (e.g., runtime component 150 of FIG. 2). The DBMS 650 illustratively includes a database 652 (e.g., database 214 of FIG. 2) and a query execution unit 654 having a query engine 656.

According to one aspect, the application 620 (and more generally, any requesting entity including, at the highest level, users) issues queries against the database 652. The database 652 is shown as a single database for simplicity. However, a given query can be executed against multiple databases which can be distributed relative to one another. Moreover, one or more databases can be distributed to one or more networked devices (e.g., networked devices 146 of FIG. 1). The database 652 is representative of any collection of data regardless of the particular physical representation of the data. A physical representation of data defines an organizational schema of the data. By way of illustration, the database 652 may be organized according to a relational schema (accessible by SQL queries) or according to an XML schema (accessible by XML queries). However, the invention is not limited to a particular schema and contemplates extension to schemas presently unknown. As used herein, the term “schema” generically refers to a particular arrangement of data.

In one embodiment, the queries issued by the application 620 are created by users using the user interface 610, which can be any suitable user interface configured to create/submit queries. According to one aspect, the user interface 610 is a graphical user interface. However, it should be noted that the user interface 610 is only shown by way of example; any suitable requesting entity may create and submit queries against the database 652 (e.g., the application 620, an operating system or an end user). Accordingly, all such implementations are broadly contemplated.

In one embodiment, the requesting entity accesses a suitable database connectivity tool such as a Web application, an Open DataBase Connectivity (ODBC) driver, a Java DataBase Connectivity (JDBC) driver or a Java Application Programming Interface (Java API) for creation of a query. A Web application is an application that is accessible by a Web browser and that provides some function beyond static display of information, for instance by allowing the requesting entity to query the database 652. An ODBC driver is a driver that provides a set of standard application programming interfaces to perform database functions such as connecting to the database 652, performing dynamic SQL functions, and committing or rolling back database transactions. A JDBC driver is a program included with a database management system (e.g., DBMS 650) to support JDBC standard access between the database 652 and Java applications. A Java API is a Java-based interface that allows an application program (e.g., the requesting entity, the ODBC or the JDBC) that is written in a high-level language to use specific data or functions of an operating system or another program (e.g., the application 620).

Accordingly, the queries issued by the application 620 can be in physical form, such as SQL and/or XML queries, which are consistent with the physical representation of the data in the database 652. Alternatively, the queries issued by the application 620 are composed using the abstract model interface 630. In other words, the queries are created on the basis of logical fields defined by the data abstraction model 632 and translated by the runtime component 634 into a concrete (i.e., executable) query for execution. As was noted above, such queries are referred to herein as “abstract queries”. An exemplary abstract model interface is described above with reference to FIGS. 2-5.

Illustratively, the application 620 issues a query 640. In one embodiment, the query 640 includes one or more result fields 642 for which data from the database 652 is to be returned, one or more conditions 644, and a conditions object 646. The conditions 644 are configured for filtering which data record(s) contained in the database 652 is(are) returned for each of the result fields 642. The conditions object 646 defines one or more expressions, each representing a conditional statement that is defined using one or more of the conditions 644. Accordingly, an expression can be used to specify requested characteristics of a group of data records.

In one embodiment, a given expression can be created by a user. For instance, the user may use the user interface 610 to select one or more of the conditions 644 to define a conditional statement on the basis of the selected condition(s). If the user selects more than one condition for a single expression, the selected conditions can be combined in the conditional statement representing the single expression using suitable Boolean operators.

An illustrative query corresponding to the query 640 is shown in Table III below. By way of illustration, the exemplary query of Table III is shown as an abstract query that is defined using XML. However, any other language may be used to advantage.

TABLE III
QUERY EXAMPLE

| | |
|---|---|
| 001 | <?xml version=“1.0”?> |
| 002 | <!--Query string representation: (Hct % Bld > “55”--> |
| 003 | <QueryAbstraction> |
| 004 | <Selection> |
| 005 | <Expression reference=“A”> |
| 006 | <Condition field=“ICD9 Code” |
| 007 | operator=“EQ” value=“205.0” |
| 008 | internalID=“1”/> |
| 009 | <Condition field=“Hct % Bld” |
| 010 | operator=“BETWEEN” value=“25” value=“50” |
| 011 | internalID=“2” relOperator=“AND”></Condition> |
| 012 | </Expression> |
| 013 | <Expression reference=“B” relOperator=“OR”> |
| 014 | <Condition field=“ICD9 Code” |
| 015 | operator=“EQ” value=“205.1” |
| 016 | internalID=“3”/> |
| 017 | <Condition field=“Hct Bld Calc-mCnc” |
| 018 | operator=“BETWEEN” value=“10” value=“15” |
| 019 | internalID=“4” relOperator=“AND”></Condition> |
| 020 | </Expression> |
| 021 | </Selection> |
| 022 | <Results> |
| 023 | <Field name=“PatientID”/> |
| 024 | <Field name=“Hemoglobin Test A (Hgb % Bld)”/> |
| 025 | <Field name=“Hemoglobin Test B (Hbg Bld |
| | Calc-mCnc)”/> |
| 026 | <Field name=“ICD9 Code”/> |
| 027 | </Results> |
| 028 | </QueryAbstraction> |

Illustratively, the abstract query shown in Table III includes a selection specification (lines 004-021) and a results specification (lines 022-027). The results specification in lines 022-027 requests for data included with PatientID, Hemoglobin Test A (Hgb % Bld), Hemoglobin Test B (Hbg Bld Calc-mCnc) and ICD9 Code fields in a corresponding underlying database. Assume now that the exemplary query of Table III is executed against an underlying database (e.g., database 652) having patient information included with a Demographic, a Diagnosis and a Tests table. Assume further that the Demographic table includes the PatientID data, the Diagnosis table includes the ICD9 Code data and the Tests table includes Hemoglobin Test data. The selection specification in lines 004-021 includes a conditions object (lines 005-020) that defines a first expression in lines 005-012 and a second expression in lines 013-020. The first expression requests data records related to patients having an ICD9 Code value which indicates a general Myeloid Leukemia diagnosis (lines 006-008) and a Hemoglobin value (Hct % Bld) between 25 and 35 (lines 009-011). The second expression requests data records related to patients having an ICD9 Code value which indicates a Chronic Myeloid Leukemia diagnosis (lines 014-016) and a Hemoglobin value (Hct Bld Calc-mCnc) between 10 and 15 (lines 017-019). Both expressions are combined using a Boolean OR operator according to line 013. In other words, the two expressions are configured to identify two distinct groups of patients according to established diagnoses and results.

It should be noted that in the exemplary query of Table III only conditions that are used to define the two expressions in lines 005-012 and 013-020 of the conditions object are illustrated, for simplicity. However, the query may also include other conditions that are not included with the defined expressions. For instance, the exemplary query of Table III may further include a condition used to restrict a corresponding query result to patients which are older than 50 years. All such possible implementations are broadly contemplated.

The issued query 640 is received by the query execution unit 654 and executed against the database 652 using the query engine 656 to determine a query result 670. It should be noted that the query execution unit 654 illustratively only includes the query engine 656, for simplicity. However, the query execution unit 654 may include other components, such as a query parser and a query optimizer. A query parser is generally configured to accept a received query input from a requesting entity, such as the application(s) 620, and then parse the received query. The query parser may then forward the parsed query to the query optimizer for optimization. A query optimizer is an application program which is configured to construct a near optimal search strategy (known as an “access plan”) for a given set of search parameters, according to known characteristics of an underlying database (e.g., the database 652), an underlying system on which the search strategy will be executed (e.g., computer system 110 of FIG. 1), and/or optional user specified optimization goals. But not all strategies are equal and various factors may affect the choice of an optimum search strategy. However, in general such search strategies merely determine an optimized use of available hardware/software components to execute respective queries. Once an access plan is selected, the query engine 656 then executes the query 640 according to the selected access plan.

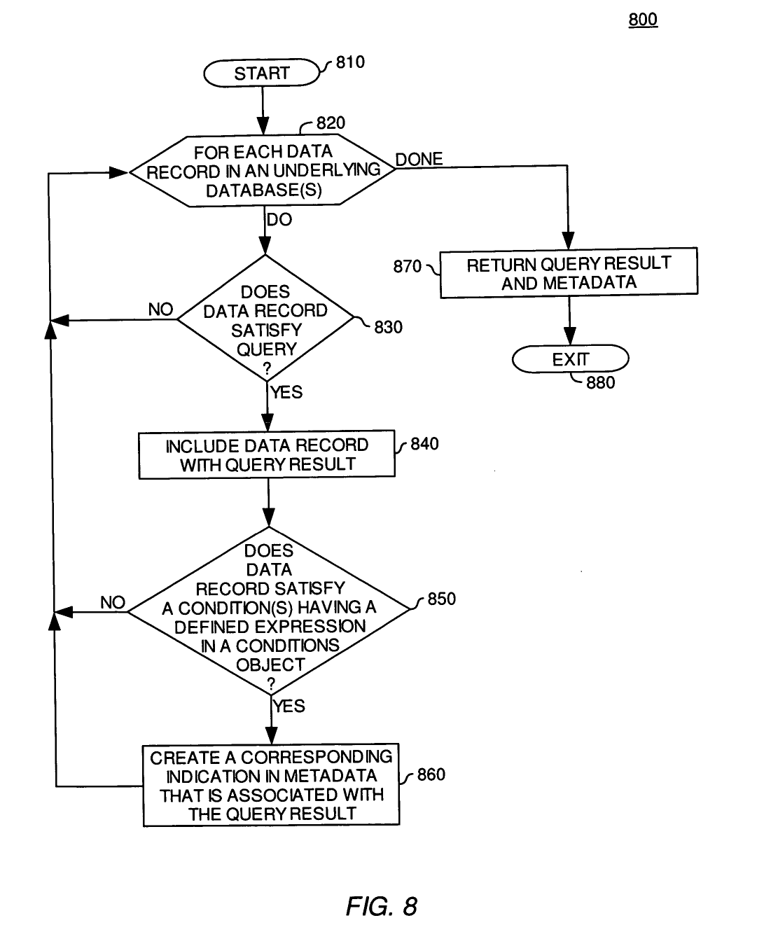

When executing the query 640 against the database 652 the query engine 656 identifies each data record of the database 652 that satisfies at least one of the conditions 644. According to one embodiment, for each identified data record, the query engine 656 determines whether one or more of the expressions defined by the conditions object 646 are satisfied. For each identified data record that satisfies at least one expression, a corresponding entry in the metadata 658 is generated. Accordingly, after execution of the query 640 against the database 652, the metadata 658 includes a list of data record identifiers for each expression defined by the conditions object 646. The list of identifiers of a given expression indicates which data record in the query result 670 satisfies the conditional statement defining the expression. An exemplary method of determining the query result 670 and the metadata 658 during query execution is described below with reference to FIG. 8.

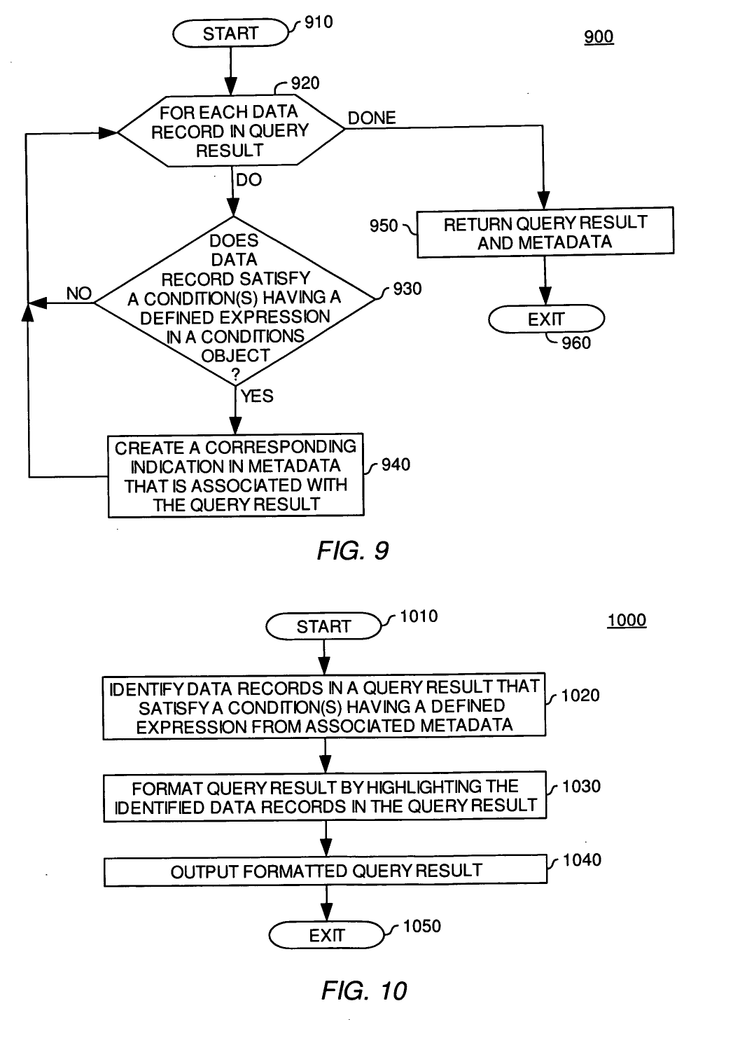

It should be noted that generating the metadata 658 during query execution is merely described by way of example. More specifically, in an alternative embodiment only the query result 670 is determined during query execution and the metadata 658 is determined after query execution. More specifically, the query result 670 can be parsed after query execution in order to determine which data record satisfies which expression defined by the conditions object 646. In this case, the metadata 658 is generated only when determination of the query result 670 is completed. Accordingly, all such different possible implementations are broadly contemplated. An exemplary method of determining the metadata 658 on the basis of the query result 670 after query execution is described below with reference to FIG. 9.

In one embodiment, the query result 670 and the metadata 658 are persistently stored for subsequent retrieval. Illustratively, the query result 670 and the metadata 658 are retrieved and processed by the output formatter 680. However, it should be noted that the output formatter 680 is merely described by way of example to illustrate a component which is suitable to implement aspects of the invention. In other words, the functions of the output formatter 680 can be implemented into other functional components. For instance, in one embodiment the functions of the output formatter 680 are implemented by the query execution unit 654. All such implementations are broadly contemplated.

In one embodiment, the output formatter 680 generates a formatted query result 690 on the basis of the query result 670 and the metadata 658. The formatted query result 690 is in a format relating the data records of the query result 670 to respective expressions of the conditions object 646 on the basis of which conditions the data records satisfy. In other words, the formatted query result 690 exposes which of the data records satisfy respective conditions having defined expressions in the conditions object 646. The formatted query result 690 is then returned to the application 620. Operation of the output formatter 680 is described in more detail below with reference to FIG. 10.

### MANAGING QUERY CREATION AND EXECUTION

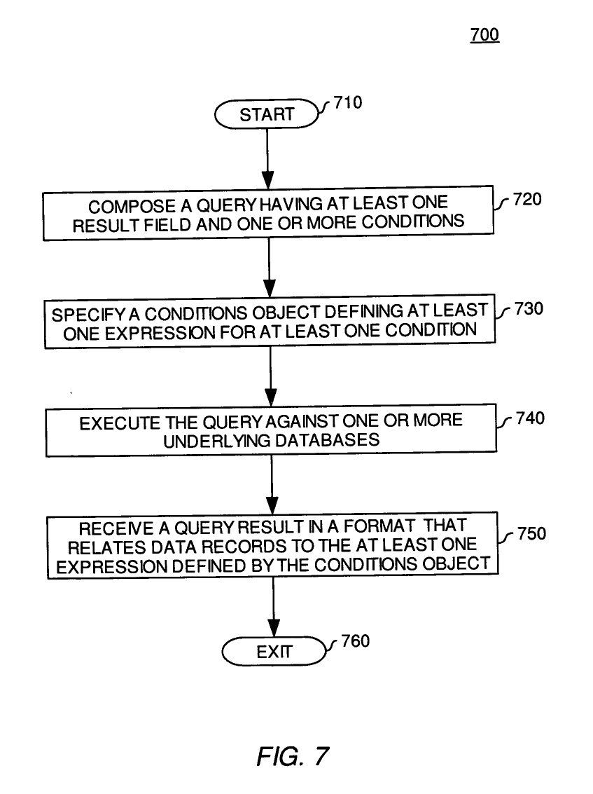

Referring now to FIG. 7, one embodiment of a method 700 for managing creation and execution of a query (e.g., query 640 of FIG. 6) having a conditions object (e.g., conditions object 646 of FIG. 6) is illustrated. In one embodiment, at least part of the steps of the method 700 is performed by the query execution unit 654 of FIG. 6. Furthermore, at least several steps of the method 700 can be performed on the basis of user input received via the user interface 610 of FIG. 6. Method 700 starts at step 710.

At step 720, a requesting entity (e.g., application 620 of FIG. 6 or a user) creates a query having at least one result field (e.g., result fields 642 of FIG. 6) and one or more conditions (e.g., conditions 644 of FIG. 6). For purposes of illustration, assume that the query is composed by a user using the user interface 610 of FIG. 6. Assume further that the user composes the exemplary query illustrated in Table IV below. For simplicity, the exemplary query of Table IV is illustrated in natural language. Persons skilled in the art will readily recognize corresponding SQL or XML representations, such as used to describe the exemplary abstract query of Tables I and III. However, it should be noted that implementation of the exemplary query of Table IV is not limited to a particular machine-readable language and that an implementation in any machine-readable language, known or unknown, is broadly contemplated.

TABLE IV
QUERY EXAMPLE

| | |
|---|---|
| 001 | FIND |
| 002 | PatientID, Hgb % Bld, Hgb Bld Calc-mCnc, ICD9 Code |
| 003 | FROM |
| 004 | Demographic, Diagnosis, Tests |
| 005 | WHERE |
| 006 | (ICD9 Code = Myeloid Leukemia OR ICD9 Code = Chronic |

Myeloid Leukemia)

| | |
|---|---|
| 007 | AND |
| 008 | (Hct % Bld Between 25 and 35 OR Hgb Bld Calc-mCnc |

Between 10 and 15)

The exemplary query of Table IV is configured to identify patient information from underlying Demographic, Diagnosis and Tests database tables (lines 003-004). More specifically, the exemplary query requests for a list of patients which have an ICD9 Code value that indicates a general Myeloid Leukemia or a Chronic Myeloid Leukemia diagnosis (line 006), and (“AND” in line 007) a Hct % Bld Hemoglobin value between 25 and 35 or a Hct Bld Calc-mCnc Hemoglobin value between 10 and 15 (line 008). The patients should be identified in a corresponding query result by their associated patient identifiers (“PatientID” in line 002). Furthermore, for each patient a corresponding ICD9 Code (“ICD9 Code” in line 002), a test result of a HCT % Bld test (“Hct % Bld” in line 002) and a test result of a Hct Bld Calc-mCnc test (“Hct Bld Calc-mCnc” in line 002) are requested.

At step 730, the user specifies a conditions object for the exemplary query of Table IV by defining one or more expressions using the conditions in lines 006 and 008 of Table IV. In one embodiment, specification of the conditions object can be performed using a suitable graphical user interface (GUI). For instance, a GUI can be configured to display a plurality of user-selectable elements, each representing a condition, such as “ICD9 Code=Myeloid Leukemia”, of the exemplary query of Table IV. By way of example, the GUI may display a condition tree having a plurality of condition nodes, each defining a single user-selectable condition. The condition nodes can be connected to each other by corresponding operator nodes representing, e.g., Boolean operators. The GUI may further display graphical elements which allow combining selected conditions into corresponding expressions and created expressions into the conditions object. However, using a GUI to specify the conditions object is merely described by way of example and not limiting of the invention. For instance, in one embodiment default expressions can be defined for a conditions object. By way of example, conditions that are combined in the exemplary query of Table IV using Boolean “OR” operators can automatically be split and combined with logically ANDed conditions into corresponding expressions. Accordingly, in the given example an automatically generated expression can be “ICD9 Code=Myeloid Leukemia AND Hgb Bld Calc-mCnc Between 10 and 15”. In other words, any possible technique for specifying the conditions object is broadly contemplated.

Assume now that the user specifies the exemplary expressions illustrated in Table V below on the basis of the conditions defined in lines 006 and 008 of the exemplary query of Table IV. For simplicity, the exemplary expressions of Table V are also illustrated in natural language.

TABLE V
EXPRESSIONS EXAMPLE

| | |
|---|---|
| 001 | EXPRESSION A IS |
| 002 | (ICD9 Code = Myeloid Leukemia AND |
| 003 | Hct % Bld Between 25 and 35) |
| 004 | OR |
| 005 | EXPRESSION B IS |
| 006 | (ICD9 Code = Chronic Myeloid Leukemia AND |
| 007 | Hgb Bld Calc-mCnc Between 10 and 15) |

It should be noted that the exemplary expression in lines 001-003 corresponds to the expression defined in lines 005-012 of the exemplary abstract query in Table III. Furthermore, the exemplary expression in lines 005-007 corresponds to the expression defined in lines 013-020 of the exemplary abstract query in Table III. Moreover, both expressions are combined using a Boolean “OR” operator so that the user may separately distinguish which data records of a corresponding query result (e.g. formatted query result 690 of FIG. 6) satisfy which of the expressions.

In one embodiment, the exemplary expressions of Table V are included with the exemplary query of Table IV above. Accordingly, the exemplary query of Table VI below is obtained.

TABLE VI
RESULTING QUERY EXAMPLE

| | |
|---|---|
| 001 | FIND |
| 002 | PatientID, Hgb % Bld, Hgb Bld Calc-mCnc, ICD9 Code |
| 003 | FROM |
| 004 | Demographic, Diagnosis, Tests |
| 005 | WHERE |
| 006 | ((ICD9 Code = Myeloid Leukemia OR ICD9 Code = Chronic |

Myeloid Leukemia)

| | |
|---|---|
| 007 | AND |
| 008 | (Hct % Bld Between 25 and 35 OR Hgb Bld Calc-mCnc |

Between 10 and 15))

| | |
|---|---|
| 009 | WITH |
| 010 | (EXPRESSION A IS |
| 011 | (ICD9 Code = Myeloid Leukemia AND |
| 012 | Hct % Bld Between 25 and 35) |
| 013 | OR |
| 014 | EXPRESSION B IS |
| 015 | (ICD9 Code = Chronic Myeloid Leukemia AND |
| 016 | Hgb Bld Calc-mCnc Between 10 and 15)) |

It should be noted that the conditions object in lines 010-016 that defines the expressions of Table V above is inserted (“WITH” line 009) at the end of the exemplary query of Table IV, by default. This allows the query execution unit 654 to recognize that a query result (e.g., query result 670 of FIG. 6) is to be determined having data records that satisfy the conditions in lines 006-008 and that associated metadata (e.g., metadata 658 of FIG. 6) is to be created with respect to the conditions object in lines 010-016.

At step 740, the user issues the query for execution against one or more underlying databases (e.g., database 652 of FIG. 6) to obtain a query result. In one embodiment, executing the query against the underlying database(s) includes generating associated metadata with respect to the conditions object. An exemplary method for executing the query against the underlying database(s) to obtain the query result and the associated metadata is described in more detail below with reference to FIG. 8.

At step 750, the user receives the query result in a format that relates data records included with the query result to the expressions defined in the conditions object (lines 010-016 of Table VI) of the underlying executed query. More specifically, in one embodiment the query result is processed to create a formatted query result (e.g., formatted query result 690 of FIG. 6) on the basis of the associated metadata. The formatted query result is then returned to the user. An exemplary method of processing the query result using the associated metadata is described in more detail below with reference to FIG. 10. Method 700 then exits at step 760.

### DETERMINING A QUERY RESULTS AND ASSOCIATED METADATA

Referring now to FIG. 8, one embodiment of a method 800 for determination of a query result (e.g., query result 670 of FIG. 6) and associated metadata (e.g., metadata 658 of FIG. 6) is illustrated. According to one aspect, the steps of the method 800 are performed by the query engine 656 of FIG. 6 on the basis of an underlying query (e.g., query 640 of FIG. 6) having a conditions object (e.g. conditions object 646 of FIG. 6). Furthermore, in one embodiment the method 800 is entered from step 740 of FIG. 7.

By way of example, the steps of method 800 are described in the following with respect to execution of the exemplary query of Table VI against an underling database(s) having Demographic, Diagnosis and Tests database tables. However, for simplicity and brevity these database tables are not illustrated in more detail. Persons skilled in the art will readily recognize possible data representations defining suitable database tables.

Method 800 starts at step 810. At step 820, a loop consisting of steps 820 to 860 is entered for each data record contained in the underlying database(s). Assume now that the loop is initially entered at step 820 for a given data record contained in the underlying database(s).

At step 830, the query engine determines whether the given data record satisfies the query. In the given example, the query engine determines whether the given data record satisfies the exemplary query of Table VI with respect to the conditions in lines 006-008 of Table VI. If the given data record does not satisfy the query, processing returns to step 820 where the loop consisting of steps 820 to 860 is entered for a next data record. If, however, the given data record satisfies the query, the data record is included with the query result at step 840.

By way of example, assume that the given data record includes a patient identifier PatientID “1” which uniquely identifies the data record, an ICD9 Code “205.0”, a test result “27” for a HCT % Bld test and a test result “5” for a Hct Bld Calc-mCnc test. Accordingly, the given data record satisfies the conditions in lines 006-008 of Table VI, as the ICD9 Code indicates a Myeloid Leukemia diagnosis and the Hct % Bld value is between 25 and 35. Thus, the given data record is included with the query result.

At step 850, the query engine determines whether the given data record further satisfies one or more of the expressions defined in the conditions object of the query. In the given example, the query engine determines whether the given data record satisfies one or more of the expressions defined in lines 010-016 of the exemplary query of Table VI. If the given data record does not satisfy any expression, processing returns to step 820 where the loop consisting of steps 820 to 860 is entered for a next data record. If, however, the given data record satisfies at least one expression, processing continues at step 860.

At step 860, the query engine creates an indication for the given data record in the associated metadata. The indication relates the given data record to the expression(s) that is satisfied by the given data record. Processing then returns to step 820 where the loop consisting of steps 820 to 860 is entered for a next data record.

In the given example, the given data record satisfies the expression “A” in lines 010-012 of Table VI, as the ICD9 Code indicates a Myeloid Leukemia diagnosis and the Hct % Bld value is between 25 and 35. Thus, an indication is generated in the associated metadata that relates the given data record to the expression “A”. For instance, the PatientID “1” which uniquely identifies the given data record is included with a list of identifiers that indicates all data records that satisfy expression “A”. Similarly, in the given example another list of identifiers can be created for data records that satisfy expression “B” (lines 014-016 of Table VI). Still another list can be created for data records that simultaneously satisfy both expressions, “A” and “B”.

When the loop consisting of steps 820 to 860 was executed for all data records contained in the underlying database(s), the query engine returns the query result and the associated metadata at step 870. Illustratively, the query result and the associated metadata are output from the query engine to the output formatter 680 of FIG. 6 for further processing, as described by way of example below with reference to FIG. 10. Method 800 then exits at step 880.

In the given example, assume that the exemplary query result illustrated in Table VII below is obtained. The exemplary query result is ordered in descending order of the patient identifiers.

TABLE VII
EXEMPLARY QUERY RESULT

| 001 | Patient ID | ICD9 Code | Hct % Bld | Hgb Bld Calc-mCnc |
|---|---|---|---|---|
| 002 | 1 | 205.0 | 27 | 5 |
| 003 | 2 | 205.1 | 17 | 11 |
| 004 | 3 | 205.0 | 34 | null |
| 005 | 4 | 205.1 | 20 | 14 |
| 006 | 5 | 205.1 | 24 | 15 |
| 007 | 6 | 205.0 | 35 | 10 |
| 008 | 12 | 205.0 | 38 | null |

As was noted above, an ICD9 Code “205.0” indicates a general Myeloid Leukemia diagnosis. An ICD9 Code “205.1” indicates a Chronic Myeloid Leukemia diagnosis. Accordingly, the data records illustrated in lines 001 and 003 of Table VII satisfy the expression “A” of lines 010-012 of Table VI. Furthermore, the data records illustrated in lines 002, 004 and 005 of Table VII satisfy the expression “B” of lines 014-016 of Table VI. Moreover, the data record illustrated in line 006 of Table VII satisfies both, the expression “A” of lines 010-012 and the expression “B” of lines 014-016 of Table VI. However, the data record illustrated in line 008 does not satisfy any of the expressions “A” and “B” of Table VI.

Assume further that the exemplary metadata illustrated in Table VIII below is generated. For simplicity, the exemplary metadata of Table VIII is illustrated in natural language. However, it should be noted that implementation of the exemplary metadata of Table VIII is not limited to a particular machine-readable language and that an implementation in any machine-readable language, known or unknown, is broadly contemplated.

TABLE VIII
EXEMPLARY METADATA

| | |
|---|---|
| 001 | EXPRESSION A IS |
| 002 | (ICD9 Code = Myeloid Leukemia AND |
| 003 | Hct % Bld Between 25 and 35) |
| 004 | EXPRESSION B IS |
| 005 | (ICD9 Code = Chronic Myeloid Leukemia AND |
| 006 | Hgb Bld Calc-mCnc Between 10 and 15) |
| 007 | A (1, 3, 6) |
| 008 | B (2, 4, 5, 6) |

Illustratively, the exemplary metadata at lines 001-006 of Table VIII includes the exemplary expressions of lines 001-003 and 005-007 of Table V above. Furthermore, the exemplary metadata at line 007 includes an indication of expression A (“A”) associated with a list of identifiers (“(1, 3, 6)”) that indicates which data records satisfy expression A, i.e., the data records in lines 002, 004 and 007 of the exemplary query result of Table VII. Similarly, line 008 includes an indication of expression B (“B”) and an associated list of identifiers (“(2, 4, 5, 6)”) indicating the data records which satisfy expression B, i.e., the data records in lines 003, 005, 006 and 007 of the exemplary query result of Table VII. As can be seen from lines 007 and 008 in Table VIII, the data record of line 007 of Table VII (PatientID “6”) is included with both lists of identifiers.

It should be noted that FIG. 8 illustrates an embodiment where the query engine generates the associated metadata during query execution. However, as noted above the associated metadata can be generated in another embodiment on the basis of an obtained query result after query execution. More specifically, the query result can be determined by executing a loop consisting of steps 820 to 840 of FIG. 8. Once the query result is determined, the query result can be parsed by the query engine or any other suitable software component to generate the associated metadata. An exemplary method of generating the associated metadata on the basis of an underlying query result is described in more detail below with reference to FIG. 9.

Referring now to FIG. 9, one embodiment of a method 900 for determination of associated metadata (e.g., metadata 658 of FIG. 6) from an underlying query result (e.g., query result 670 of FIG. 6) is illustrated. According to one aspect, the steps of the method 900 are performed by the query engine 656 of FIG. 6 on the basis of an underlying query (e.g., query 640 of FIG. 6) having a conditions object (e.g. conditions object 646 of FIG. 6).

Method 900 starts at step 910. At step 920, a loop consisting of steps 920 to 940 is entered for a given data record contained in the underlying query result. For instance, assume that the underlying query result is the exemplary query result of Table VII and that the loop is initially entered for the data record in line 002 of Table VII.

At step 930, the query engine determines whether the given data record satisfies one or more of the expressions (lines 010-016 of Table VI) defined in the conditions object of the query. If the given data record does not satisfy any expression, processing returns to step 920 where the loop consisting of steps 920 to 940 is entered for a next data record. If, however, the given data record satisfies at least one expression, processing continues at step 940.

At step 940, the query engine creates an indication for the given data record in the associated metadata as described above with reference to step 860 of FIG. 8. In the given example, the query engine creates the indication “1” in line 007 of the exemplary metadata of Table VII for the given data record. Processing then returns to step 920 where the loop consisting of steps 920 to 940 is entered for a next data record.

When the loop consisting of steps 920 to 940 was executed for all data records contained in the underlying query result, the query engine returns the query result and the associated metadata at step 950 as described above with reference to step 870 of FIG. 8. Method 900 then exits at step 960.

### FORMATTING A QUERY RESULTS USING ASSOCIATED METADATA

Referring now to FIG. 10, one embodiment of a method 1000 for formatting a query result (e.g., query result 670 of FIG. 6) on the basis of associated metadata (e.g., metadata 658 of FIG. 6) is illustrated. According to one aspect, the steps of the method 1000 are performed by the output formatter 680 of FIG. 6. Furthermore, in one embodiment the method 1000 is entered from step 750 of FIG. 7.

By way of example, the steps of method 1000 are described in the following with respect to the exemplary query result of Table VII and the exemplary associated metadata of Table VII above. Method 1000 starts at step 1010.

At step 1020, the output formatter identifies each data record in the query result which satisfies one or more expressions. To this end, the output formatter accesses the associated metadata and parses all lists of identifiers that are associated with corresponding expressions. Accordingly, in the given example the output formatter determines (i) from line 007 of Table VII that the data records in lines 002 (PatientID “1”), 004 (PatientID “3”) and 007 (PatientID “6”) of the exemplary query result of Table VII satisfy expression A, and (ii) from line 008 of Table VII that the data records in lines 003 (PatientID “2”), 005 (PatientID “4”), 006 (PatientID “5”) and 007 (PatientID “6”) of the exemplary query result of Table VII satisfy the expression B, and (iii) from lines 007 and 008 of Table VII that the data record of line 007 of Table VII (PatientID “6”) satisfies both expressions, i.e. A and B.

At step 1030, the output formatter formats the query result to render a format relating the identified data records to the corresponding expressions. In one embodiment, rendering the format includes creating a visual reference of an identified data record to each expression that is satisfied by the data record. For instance, each data record related to a given expression can be highlighted in a manner that distinguishes the data record from one other data records in the query result that are related to other expressions. In one embodiment, highlighting includes associating each data record related to a particular expression with an indication of the expression. Furthermore, data records which satisfy a given expression can be presented separate from data records that are related to a different expression. Accordingly, data records which satisfy different expressions can be displayed in distinct frames or tabs on a display.

However, it should be understood that these rendering techniques are merely described by way of example. Multiple other rendering techniques are also possible. For instance, data records which satisfy different expressions can be displayed in distinct colors according to a predefined visual color scheme, whereby each data record related to a particular expression is displayed in a specific color associated with the expression. Accordingly, all such possible implementations are broadly contemplated.

Assume now that the output formatter has formatted the exemplary query result of Table VII on the basis of the exemplary associated metadata of Table VIII by associating each data record related to a particular expression with an indication of the expression. Accordingly, the exemplary formatted query result (e.g., formatted query result 690 of FIG. 6) illustrated in Table IX below is obtained.

TABLE IX
UZ,6/27 EXEMPLARY FORMATTED QUERY RESULT

| | | | | | Hgb Bld |
|---|---|---|---|---|---|
| 001 | Expression | Patient ID | ICD9 Code | Hct % Bld | Calc-mCnc |
| 002 | A | 1 | 205.0 | 27 | 5 |
| 003 | B | 2 | 205.1 | 17 | 11 |
| 004 | A | 3 | 205.0 | 34 | null |
| 005 | B | 4 | 205.1 | 20 | 14 |
| 006 | B | 5 | 205.1 | 24 | 15 |
| 007 | A, B | 6 | 205.0 | 35 | 10 |
| 008 | null | 12 | 205.0 | 38 | null |
| 009 | | | | | |

| | |
|---|---|
| 010 | EXPRESSION A IS |
| 011 | (ICD9 Code = Myeloid Leukemia AND |
| 012 | Hct % Bld Between 25 and 35) |
| 013 | EXPRESSION B IS |
| 014 | (ICD9 Code = Chronic Myeloid Leukemia AND |
| 015 | Hgb Bld Calc-mCnc Between 10 and 15) |

As can be seen from Table IX, each of the data records in lines 002-007 is associated with an indication of an expression(s) that is satisfied by the data record. As the data record in line 008 does not satisfy any expression, this data record includes a null value in the expression field. Furthermore, the expressions A and B are summarized in lines 010-015.

At step 1040, the output formatter outputs the formatted query result. For instance, the output formatter outputs the formatted query result to the application 620 of FIG. 6. Method 1000 then exits at step 1050.

While the foregoing is directed to embodiments of the present invention, other and further embodiments of the invention may be devised without departing from the basic scope thereof, and the scope thereof is determined by the claims that follow.

What is claimed is:

1. A method for managing presentation of a query result, comprising:
receiving, from a requesting entity, a query having at least:
(i) one result field for which data from one or more databases is to be returned;
(ii) one or more conditions for filtering which of the data contained in the one or more databases is returned for each result field; and
(iii) a conditions object defining at least one expression for at least one of the conditions;
executing the query against the one or more databases to obtain a query result having one or more data records; and
returning the query result in a format relating the data records to respective expressions on the basis of which conditions the data records satisfy, thereby exposing which of the data records satisfy respective conditions having defined expressions in the conditions object.

2. The method of claim 1, wherein executing the query comprises generating metadata identifying each data record that satisfies conditions for which an expression is defined in the condition object.

3. The method of claim 2, further comprising:
persistently storing the query result and the generated metadata to allow subsequent retrieval thereof.

4. The method of claim 2, wherein returning the query result in a format relating the data records to respective expressions comprises returning the obtained query result and the generated metadata.

5. The method of claim 2, further comprising:
formatting the query result to render the format relating the data records to respective expressions on the basis of which conditions the data records satisfy; wherein formatting comprises highlighting each data record related to each of the expressions in a manner that distinguishes the expressions from one another in the query result.

6. The method of claim 5, wherein the formatting further comprises determining each data record related to one of the expressions using the metadata.

7. The method of claim 5, wherein highlighting each data record related to each of the expressions comprises at least one of:
(i) associating each data record related to a particular expression with an indication of the expression;
(ii) displaying each data record related to a particular expression in a specific color associated with the expression; and
(iii) displaying all data records related to a particular expression separate from data records that are related to a different expression.

8. The method of claim 1, further comprising:
formatting the query result to render the format relating the data records to respective expressions on the basis of which conditions the data records satisfy; wherein formatting comprises for each data record that satisfies at least one group of conditions having at least one defined expression in the conditions object at least one of:
(i) associating the data record with an indication of the at least one defined expression;
(ii) displaying the data record in a specific color associated with the at least one defined expression; and
(iii) displaying the data record together with all other data records that satisfy the at least one group of conditions separate from other data records that are not satisfying the at least one group of conditions.

9. The method of claim 1, further comprising:
after executing the query to obtain the query result, identifying each data record in the query result that satisfies conditions for which an expression is defined in the condition object.

10. The method of claim 9, further comprising:
generating metadata indicating each identified data record; wherein returning the query result in a format relating the data records to respective expressions comprises returning the obtained query result and the generated metadata.

11. The method of claim 1, wherein each condition is defined using one or more logical fields of a data abstraction model abstractly describing the data in the database; whereby the query defines an abstract query, and wherein the data abstraction model is adapted for transforming the one or more logical fields of the abstract query into a form consistent with a physical representation of the data in the database.

12. A computer-readable medium containing a program which, when executed by a processor, performs a process for managing presentation of a query result, the process comprising:
receiving, from a requesting entity, a query having at least:
(i) one result field for which data from one or more databases is to be returned;
(ii) one or more conditions for filtering which of the data contained in the one or more databases is returned for each result field; and
(iii) a conditions object defining at least one expression for at least one of the conditions;
executing the query against the one or more databases to obtain a query result having one or more data records; and
returning the query result in a format relating the data records to respective expressions on the basis of which conditions the data records satisfy, thereby exposing which of the data records satisfy respective conditions having defined expressions in the conditions object.

13. The computer-readable medium of claim 12, wherein executing the query comprises generating metadata identifying each data record that satisfies conditions for which an expression is defined in the condition object.

14. The computer-readable medium of claim 13, wherein the process further comprises:
persistently storing the query result and the generated metadata to allow subsequent retrieval thereof.

15. The computer-readable medium of claim 13, wherein returning the query result in a format relating the data records to respective expressions comprises returning the obtained query result and the generated metadata.

16. The computer-readable medium of claim 13, wherein the process further comprises:
formatting the query result to render the format relating the data records to respective expressions on the basis of which conditions the data records satisfy; wherein formatting comprises highlighting each data record related to each of the expressions in a manner that distinguishes the expressions from one another in the query result.

17. The computer-readable medium of claim 16, wherein the formatting further comprises determining each data record related to one of the expressions using the metadata.

18. The computer-readable medium of claim 16, wherein highlighting each data record related to each of the expressions comprises at least one of:
(i) associating each data record related to a particular expression with an indication of the expression;
(ii) displaying each data record related to a particular expression in a specific color associated with the expression; and
(iii) displaying all data records related to a particular expression separate from data records that are related to a different expression.

19. The computer-readable medium of claim 12, wherein the process further comprises:
formatting the query result to render the format relating the data records to respective expressions on the basis of which conditions the data records satisfy; wherein formatting comprises for each data record that satisfies at least one group of conditions having at least one defined expression in the conditions object at least one of:
(i) associating the data record with an indication of the at least one defined expression;
(ii) displaying the data record in a specific color associated with the at least one defined expression; and
(iii) displaying the data record together with all other data records that satisfy the at least one group of conditions separate from other data records that are not satisfying the at least one group of conditions.

20. The computer-readable medium of claim 12, wherein the process further comprises:
after executing the query to obtain the query result, identifying each data record in the query result that satisfies conditions for which an expression is defined in the condition object.

21. The computer-readable medium of claim 20, wherein the process further comprises:
generating metadata indicating each identified data record; wherein returning the query result in a format relating the data records to respective expressions comprises returning the obtained query result and the generated metadata.

22. The computer-readable medium of claim 12, wherein each condition is defined using one or more logical fields of a data abstraction model abstractly describing the data in the database; whereby the query defines an abstract query, and wherein the data abstraction model is adapted for transforming the one or more logical fields of the abstract query into a form consistent with a physical representation of the data in the database.
